(19) United States
(12) Patent Application Publication
(10) Pub. No.: US 2021/0301585 A1
(43) Pub. Date: Sep. 30, 2021

(54) PROFILE FOR A WINDOW AND/OR DOOR PART WITH METAL LAYER WITH FIBER LAYER

(71) Applicant: Salamander Industrie-Produkte GmbH, Tuerkheim (DE)

(72) Inventor: Till Schmiedeknecht, Muenchen (DE)

(73) Assignee: Salamander Industrie-Produkte GmbH, Tuerkheim (DE)

(21) Appl. No.: 17/214,257

(22) Filed: Mar. 26, 2021

(30) Foreign Application Priority Data
Mar. 27, 2020 (DE) 102020108568.0

(51) Int. Cl. E06B 3/22

(52) U.S. Cl. CPC E06B 3/222; E06B 2003/228; E06B 2003/224

(57) ABSTRACT

An extrusion profile, such as a mono- or co-extrusion profile, for a door and/or window part, may include a fiber layer laminated at least partially to an outer side of the profile using an adhesive.

### CROSS REFERENCE TO RELATED APPLICATIONS

This patent application claims priority to German Patent Application No 10 2020 108 568.0, filed Mar. 27, 2020, which is incorporated herein by reference in its entirety.

### BACKGROUND

### Field

The present disclosure relates to a profile, in particular an extrusion profile, such as a monoextrusion or co-extrusion profile, for a window and/or door part, in particular a window and/or door frame part or a window and/or door leaf part, and to a method for producing such a profile.

### Related Art

In the prior art, it is known to increase the attractiveness of door and/or window frames by laminating the visible outer or inner sides of the frames with a plastic film, which is intended to imitate, for example, a wooden appearance, a concrete-like appearance or the like. The use of plastic is increasingly frowned upon in most industries these days. There is therefore a fundamental demand for more environmentally friendly products. At the same time, there is an increasing demand for customized, individualized door and/or window frame parts.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 a cross-sectional view of a Polyvinyl Chloride (PVC) extrusion profile with attached aluminum screen;

FIG. 2 a profile according to an exemplary embodiment of the disclosure in a sectional view;

FIG. 3 schematic representation of an exemplary embodiment of a connection region of a profile according to the disclosure; and

FIG. 4 schematic representation of a section of a manufacturing plant for a profile according to an exemplary embodiment of the disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

An object of the present disclosure to overcome the disadvantages of the prior art, in particular to simplify the production of individualized and/or environmentally friendly profiles for window and/or door frame parts or window and/or door leaf parts.

According to this, a profile is provided for a window and/or door part, for example a door and/or window frame part or a door and/or window leaf part. The profile may be, for example, a profile made in particular of plastic, such as PVC, in particular an extrusion profile, for example a monoextrusion profile or a co-extrusion profile. Generic profiles can be produced, for example, by pultrusion or by extrusion. In the context of the present disclosure, the terms extrusion profile, monoextrusion profile or co-extrusion profile are to be understood as meaning that the corresponding profile is produced by extrusion, monoextrusion or co-extrusion, respectively. The extrusion process may be monoextrusion or co-extrusion.

The profile according to an exemplary embodiment of the disclosure can, for example, at least in sections form a door and/or window part, such as a bar, such as a vertical bar or a horizontal bar, either of a fixed door and/or window frame part or of a movable, in particular displaceable and/or pivotable, door and/or window leaf part. In the case where the profile is formed as a plastic extrusion profile, the profile first comprises an extrusion semi-finished product produced by extrusion, which has a substantially identical cross-section along the extrusion direction as well as a substantially identical outer dimension.

According to an exemplary embodiment the disclosure, the profile comprises a fiber layer laminated by means of an adhesive at least partially to an outer side of the profile, in particular to a profile web forming an outer side of the profile and/or facing outwardly. In the context of the present disclosure, the fibers forming the fiber layer may be a linear, elongated structure with a cross-sectional shape that is round, angular, or the like, and is thin and flexible in relation to its length. Generally, fibers are characterized by the fact that they cannot absorb compressive forces in the longitudinal direction, but only tensile forces. Laminating is generally understood to mean the connection of a plurality of layers by means of a laminating agent comprising at least one adhesive according to the present disclosure. Lamination of the particularly thin and/or flexible fiber ply has proven to be particularly advantageous with respect to production, since, on the one hand, the fiber plies can be stocked in a simple and space-saving manner, for example by winding them onto a stock roll, and, on the other hand, the lamination process is surprisingly well suited not only for plastic films but also for fiber plies. The flexible fiber layer can be elastically stretched or bent to a certain extent, in particular in such a way that it can be easily applied to non-planar profile surfaces and adapted in shape in this respect. According to the present disclosure, a fiber layer can be understood as flexible if it can be wound or rolled onto a roll, in particular for stocking purposes. The thin fiber layers can be adapted and laminated to even irregular profile outer surfaces in a particularly form-fitting and true-to-shape manner, so that a uniform, durable and accurately fitting lamination of the corresponding profile outer surface can be ensured. Another advantage is that the fiber layer does not have to be exactly dimensioned in relation to the area of the outer side of the profile to be laminated, but may well be larger in size, since this can be separated by means of simple finishing steps such as trimming. The lamination of the metal layer, as opposed to subsequent pinning, also has the manufacturing advantage that the lamination process can be integrated directly into the extrusion process.

In an exemplary embodiment of the profile according to the disclosure, the fiber layer comprises at least 50%, in particular at least 60%, 70%, 80% or at least 90%, natural fibers or is made from renewable raw materials to at least 50%, in particular at least 60%, 70%, 80% or at least 90%. Natural fibers are understood to be all fibers that come from natural sources, such as plants, animals or minerals, and/or are present without further chemical additives. Furthermore, at least 50%, in particular at least 60%, 70%, 80% or at least 90%, of the fiber layer may be made from renewable raw materials. For example, the fibers are regenerated fibers made from naturally occurring, renewable raw materials via chemical processes, for example cellulose-based.

According to an exemplary embodiment of the profile according to the disclosure, the fiber layer, in particular the fibers of the fiber layer, is selected from the group consisting of textile fibers, wood fibers, leather fibers and leather fiber materials. For example, the textile fiber ply is formed into a flat textile structure, such as a nonwoven, a woven fabric, in particular in plain weave, a knitted fabric, a braided fabric and/or felt. The textile may be, for example, woven cotton, velvet, printed cotton, catun, satin, silk, burlap, or the like. For example, the textile may be 100% polyester and/or woven and/or pigmented on at least one side and/or provided with a PUR coating. The plain weave has proven to be particularly preferred, especially with regard to post-processing. For example, common outdoor fabrics can be used. The plain weave has proved to be particularly advantageous, since fabric produced in this way tends to fray at the least during any trimming that may be necessary in the lamination process and/or when the profile is milled by a window manufacturer.

Wood fibers are generally elongated wood cells that serve to strengthen the wood and can be obtained from wood by mechanical defibration, also called wood pulps. The wood fibers or wood pulps can be further processed in the form of a veneer of, for example, a thickness in the range of 0.5 mm to 8 mm. Leather is generally defined as an animal hide made chemically durable by tanning, the natural fiber structure of which is largely preserved. Leather fibers that can be further processed into a leather fiber fabric, also known as lefa, are made from chrome shavings and shredded vegetable-tanned leather residues, natural latex, natural fats and tanning agents. For example, a leather fiber fabric of the applicant called Cabra may be used. The leather fiber cloth may have a percentage of total weight in terms of dry matter of the total leather fiber cloth of about 50 wt. % to 85 wt. %, a binder percentage of 7 wt. % to 40 wt. %, and a percentage of additives, such as pigments, auxiliaries, etc., in the range of 0 wt. % to 10 wt. %. For example, the leather fiber cloth may have a material moisture content in the range of 8% to 12%.

In a further exemplary embodiment of the profile according to the disclosure, the textile fibers have a fluid-repellent, in particular hydrophobic, and/or particle-repellent, in particular dirt- and/or dust-particle-repellent, property. A fluid-repellent and/or particle-repellent property is generally understood to be a tendency of the textile fiber layer to block fluids, such as water or the like, as well as particles from the environment. The fluid-repellent and/or particle-repellent property can result in fluid and/or dust particles at least partially beading off the textile fiber layer, in particular not entering the interior of the fiber layer. In this way, permanent adhesion of particles to the fiber layer can be avoided and a kind of self-cleaning effect can be generated, which can manifest itself, for example, by the particles preferably running off the fiber layer in the direction of gravity, in particular dripping off. Preferably, the fluid-repellent, in particular hydrophobic, and/or particle-repellent, in particular dirt- and/or dust-particle-repellent, finish is provided only on the outer side opposite the bonding or adhesive surface, in particular so as not to impair the adhesion to the adhesive built up.

The surface free energy, which in the case of liquids such as water is also the surface tension, can be used as a measure of the fluid-repellent, in particular hydrophobic, property. For example, the contact angle, also called the edge angle or wetting angle, between liquid particles, in particular liquid droplets, and the layer surface can be used to determine the surface energy. The surface free energy and/or contact angle can be determined, for example, by reference to DIN 5660-2 “Paints and varnishes—Wettability—Part 2: Determination of the free surface energy of solid surfaces by measuring the contact angle”, which is incorporated herein by reference in its entirety. The following relationship exists: a contact angle of less than 90° indicates a fluidphilic, in particular hydrophilic, surface property; a contact angle of about 90° indicates an indifferent surface with respect to, for example, hydrophobicity; a contact angle of greater than 90°, according to the present disclosure, indicates a fluid-repellent, in particular hydrophobic, surface property, depending on the fluid involved. To determine the surface energy based on the contact angle, for example, the Owens-Wendt-Rabel-Kaeble (OWRK) method known in the literature can be used. For the purposes of the present disclosure, dirt and/or dust particles have common particle or grain sizes that can act when the profile is used, for example, as a door and/or window part.

According to an exemplary embodiment of the profile according to the disclosure, the textile fibers are subjected to a treatment modifying the fluid-repellent and/or particle-repellent property of textile.

In exemplary embodiment of the profile according to the disclosure, the fluid-repellent and/or particle-repellent property is applied by spraying or coating, in particular printing, the textile fiber ply, in particular with a silane-based solution, such as a commercially available silane-based hydrophobizing agent. The fluid-repellent and/or particle-repellent property can be effected by an inorganic and/or organic surface modification of the fiber ply. For example, the coating agent may be diluted with water or organic solvents, such as alcohol, such that in particular a mixing ratio of 0.2%-25% coating agent and 75%-99.8% water or organic solvent is included, and may further be activated prior to the coating, spraying or printing process. For example, the fluid repellent and/or particle repellent property can be applied in such a way that after coating, spraying or printing, the so-called carrier liquid, i.e. the water or organic solvent, evaporates while the coating agent remains on the textile fiber layer. For example, the coating, printing or spraying is a surface modification that causes, for example, a change in the single fiber surface of the textile layer. In particular, the spraying, coating or printing can be understood macroscopically as a type of impregnation. According to an exemplary further development, a penetration depth of the fluid-repellent and/or particle-repellent property, preferably a coating, spraying or printing depth, can be adjustable or set by means of a contact pressure of a printing aid, such as a pressure roller, for printing the upstream layer.

In an exemplary embodiment, the textile fiber layer can be subjected to a treatment that alters the fluid-repellent and/or particle-repellent property of the textile in such a way that a bonding or adhesive surface of the textile fiber layer to be bonded to the profile, in particular to be bonded, is free from a treatment that alters the fluid-repellent and/or particle-repellent property. This can ensure that a sufficient adhesion build-up can be accompanied by the adhesive and that the adhesion build-up is not impaired by, for example, a coating. For example, it can be provided that a gradient results with respect to the fluid-repellent and/or particle-repellent property which, starting from an outer side of the textile fiber layer opposite the adhesive surface, decreases, for example continuously or abruptly, towards the adhesive side.

In an exemplary embodiment, the fiber ply is a leather fiber fabric having a leather content in the range from 50 wt. %, in particular from 65 wt. %, to 85 wt. % a binder content in the range from 7 wt. %, in particular from 10 wt. %, to 40 wt. %, in particular to 20 wt. %, and optionally a content of at least one additive, such as a pigment, of at most 10 wt. %, based on a total dry mass of the fiber ply.

In an exemplary embodiment of the profile according to the disclosure, the leather fiber material is provided with at least one pigmentation comprising at least one lightfast pigment. The at least one lightfast pigment ensures the reflection of radiation, in particular UV radiation, and thus improves the installation of the profile as a door and/or window part, even in outdoor applications. For the purposes of the present disclosure, the term “lightfastness” is used as a measure of the color fastness of a material, in particular a surface material. To determine lightfastness, it is analyzed whether the colors of the material, in particular the surface material, fade and/or change color when exposed to direct or indirect light. Lightfast materials, especially surface materials, do not lose any or hardly any of their color intensity even when exposed to direct sunlight. Sunlight with a high UV light content in particular has a decomposing effect on many materials, especially surface materials, which can lead to visible color changes. Such color changes have not only aesthetic but also technical disadvantages.

Extrusion profiles, for example made of plastic, for window and/or door parts, in particular window and/or door frame parts or window and/or door leaf parts, are affected by ultraviolet (UV) rays and infrared (IR) rays of varying intensity depending on the type of light. Since such extrusion profiles are permanently exposed to weather conditions, in particular UV radiation, for a long time, these rays can trigger reactions in the plastic material over time that lead to embrittlement and/or fading.

In an exemplary embodiment, the light fastness can be determined by any method familiar to the skilled person. For example, the lightfastness can be determined by an exposure method according to DIN 513: 1999-10, in which the color temperature is measured at a total irradiation power of about 12 GJ/m² in the wavelength range from 300 nm to 800 nm. The individual steps of the methods for determining lightfastness and weather fastness will be dealt with in detail later in the examples.

In an exemplary embodiment, the fiber ply has a thickness of less than 1.0 mm, particularly a thickness in the range of 0.05 mm to 0.5 mm. For example, the leather fiber ply may have a ply thickness of about 0.35 mm, the textile fiber ply may have a thickness in the range of 0.1 mm to 0.3 mm, and the wood veneer fiber ply may have a thickness in the range of 0.35 mm. For example, the wood veneer fiber layer may be coated with a fabric layer. For example, the fabric layer can serve as an adhesive base for bonding.

In an exemplary embodiment, a connecting surface, in particular an adhesive surface, of the fiber ply to be connected to the profile is at least partially coated with a varnish.

A paint is generally a liquid or even powder coating material that is applied to the connection surface, for example sprayed on, rolled on or the like, and forms a generally continuous solid film from the surface.

In an exemplary embodiment of the profile according to the disclosure, the paint comprises polyester gel paint, epoxy resin paint, alkyd resin paint, acrylic paint, Polyurethane (PU) paint and/or a Polyvinylidene Fluoride (PVDF) coating.

According to an exemplary embodiment of the profile according to the disclosure, the adhesive is in particular a single-component hotmelt adhesive, in particular PU-based. Furthermore, a layer thickness of the adhesive can be greater than 60 g/sqm, in particular in the range from 80 g/sqm to 100 g/sqm. The layer thickness may further be in the range of 80 g/sqm to 100/sqm. The adhesive may be, for example, a so-called polyester polyurethane (PUR) hot melt, in particular a reactive PU hot melt, which, in addition to solidifying on cooling, also cures chemically, usually with the inclusion of moisture, and thus builds up a higher adhesion than a pure hot melt. Hot-melt adhesives of this type, also known as hot-melt adhesives, hot-melt glues or hot-melt adhesives, are generally solvent-free or water-free types of adhesive that are usually solid at room temperature, are present as a viscous liquid when heated and can thus be reliably applied to an adhesive surface to be bonded and, when cooled, form a solid bond between the bonding partners with reversible solidification. These adhesive types usually comprise thermoplastic polymers.

Particularly when using a textile fiber ply, the use of a varnish has proven to be advantageous with regard to post-processing and also with regard to cutting the textile fiber ply to length. The textile fibers tend to fray less when a varnish is applied, for example when it is necessary to cut the textile fiber ply to size and/or to cut out recesses for separate door and/or window parts, such as handles, fittings or the like.

According to exemplary embodiment of the present disclosure, which can be combined with the preceding aspects and exemplary embodiments, a method for producing an extrusion profile, in particular according to the disclosure, is provided. In the method according to the disclosure, an extrusion semi-finished product is produced by means of extrusion, in particular by means of co-extrusion, for example from plastic. The extrusion semi-finished product is generally said to have a uniform dimension in the extrusion direction and an identical cross-section. Furthermore, according to the disclosure, a fiber layer is at least partially laminated onto an outer side of the extrusion semifinished product by means of an adhesive. The method may be configured to produce a profile according to any of the exemplary embodiments or aspects of the present disclosure.

According to an exemplary embodiment of the present disclosure, so that the preceding aspects and exemplary embodiments can be combined, a door and/or window part, in particular a preferably fixed door and/or window frame part or a preferably movable door and/or leaf part is provided. The door and/or window part according to the disclosure comprises a profile according to the disclosure. Furthermore, it may be provided that the door and/or window part comprises a profile, in particular an extrusion profile, produced by means of the method according to the disclosure.

FIG. 1 shows a sectional view of a plastic extrusion profile, generally designated by the reference numeral 100, onto which an aluminum screen 105 is fitted on an outer side facing away from the interior of the building in order, on the one hand, to give the plastic extrusion profile an aluminum appearance and, on the other hand, to protect the plastic extrusion profile from the effects of the weather by means of the aluminum screen. A glazing 107 is inserted into a receptacle 109 and sealed off from the adjacent profile parts of the extrusion profile 100 by means of two sealing elements 111, 113 on both sides of the glazing 107. The extrusion profile 100 according to FIG. 1 has a multi-part structure and, in addition to a profile base 115, has an end profile 117 facing the interior of the building, which is connected in a form-fitting manner to the profile base 115 on the one hand and which has a sealing surface 119 to which a seal 111 is attached for sealing with respect to the glazing 107. In sectional view, the profile base 115 has a substantially L-shaped outer contour, so that towards the outer side the profile base 115 overlaps with the glazing 107, the overlap region being covered with a seal 113, the so-called glazing seal 113, in order to seal the glazing 107 on both sides. An extrusion profile outer side 121 facing away from the building interior is formed by a substantially rectilinearly extending profile outer web 123 of constant wall thickness, which merges integrally into a sealing web 125 arranged at an angle to the profile outer web 21 and extending in the direction of the glazing 107 to delimit a sealing gap 127 to be sealed.

The aluminum screen 105 is adapted to a shape of the outer profile web 123 and the sealing web 125, so that the aluminum screen 105 completely covers the extruded plastic profile 103 toward the outer side. In the area of the glazing 107, the sealing gap 127 is formed between an angled end portion 129 of the aluminum screen 105 and the planar extension of the glazing 107. In this area, a glazing seal 113 specially formed for the extruded profile 103 is inserted. Compared to plastic extrusion profiles without aluminum screen 105, glazing seal 113 has been modified to seal the resulting different sealing gap dimension 127.

At the other end 131 of the aluminum screen 105, the aluminum screen 105 has an end portion that is U-shaped in cross-section and is so arranged around one end of the outer profile web 123. Through the angled ends 129, 131, the aluminum screen 105 is positively attached to the plastic extrusion profile 103, namely pushed on and clipped on.

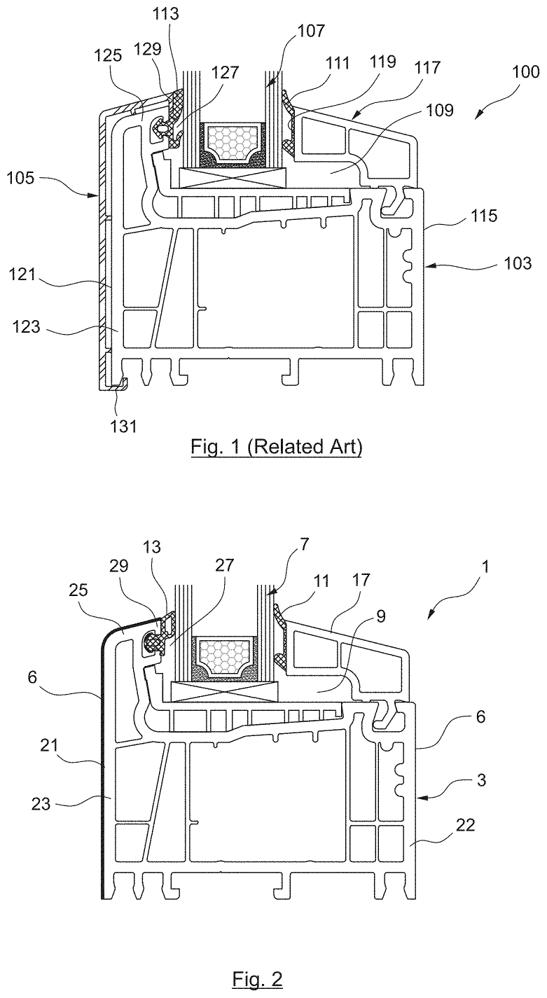

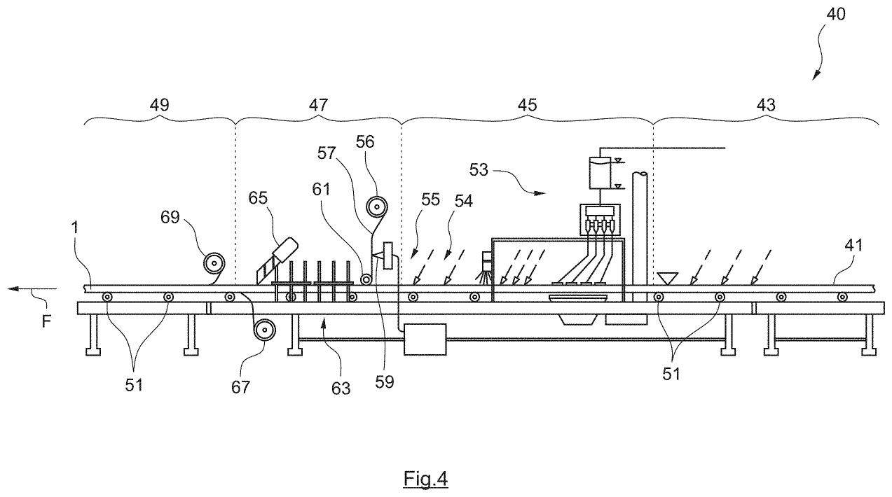

With reference to FIG. 2, an exemplary embodiment of a profile according to the disclosure, generally provided with reference numeral 1, is described. To avoid repetition, the same components are given the same terminology, with reference numerals reduced by 100. In the exemplary embodiments of profiles 1 according to the disclosure of FIGS. 2 to 6, the profiles in question are, by way of example, extrusion profiles 1 made of plastic, in particular PVC, which are produced by means of extrusion. The extrusion can be carried out by means of monoextrusion or co-extrusion.

In contrast to the attached and latched aluminum panel 105, a fiber layer 6, for example made of textile, wood veneer or leather fiber material, is laminated onto the outer profile web 23 facing away from the building interior. The fiber layer 6 has a layer thickness of less than 1.0 mm, which is constant along its longitudinal extent and flexible due to its thin dimensioning. It is clear that the fiber layer 6 can also be laminated to an inner profile web 22 opposite the outer profile web 23, or that this can be additionally laminated with a fiber layer 6 in order to give the extrusion profile 3 a desired appearance on the inside as well. The manufacturing process will be discussed in detail later. The advantage of laminating the fiber layer 6 is in particular that, on the one hand, the fiber layer 6 lies directly on the extrusion profile 1, so that a particularly compact structure is provided. Furthermore, the fiber layer 6 can be dimensioned such that it substantially exclusively covers the visible area of the corresponding profile webs 23, 22 of the extrusion profile 3. It is not necessary for the fiber layer 6 to protrude into the sealing gap 27, for example in the area of the glazing, for example in order to ensure fastening as is the case with the aluminum screen 105. The same applies to the other end of the outer profile web 23, which the fiber ply 6 does not have to embrace. In the area of the glazing 7, this has a particularly advantageous effect, since recourse can be had to the standard glazing seals 13, so that no separate fabrications are necessary for the glazing seal 113, as is the case, for example, with the use of the aluminum screen 105. The fastening by means of lamination is significantly stronger and thus more durable than with the prior art clipping of, for example, additional aluminum screen 105.

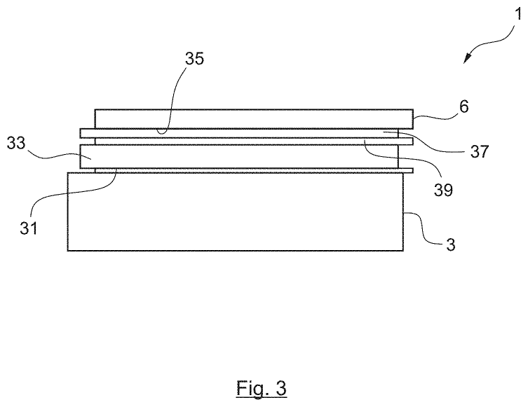

FIG. 3 shows a schematic section of an extrusion profile 1 according to an exemplary embodiment of the disclosure, with the connection area between fiber layer 6 significantly enlarged and shown schematically. The resulting layer structure is now described starting in each case from bottom to top. A so-called primer 31 is first applied to the plastic extrusion profile 3, which ensures particularly good adhesion of the subsequent adhesive 33. The fiber layer 6 can be at least partially coated with a bonding agent 37 at least on the connection surface 35 facing the plastic extrusion profile 3. In FIG. 3, it can additionally be seen that an optional varnish 39, such as a topcoat or a clear varnish, can be introduced between the bonding agent 37 and the adhesive layer 33. For example, in the case of fiber plies 6 made of textile, the use of a varnish layer 39, for example of acrylic, polyester, epoxy resin or a PU varnish, has proven to be advantageous in that the milling suitability can be significantly increased, which is advantageous when cutting textile fiber plies 6 to length and/or when milling out openings (not shown), for example for window handles or fittings or the like. The textile coated with the varnish 39 no longer frays so easily, so that the quality of the textile fiber ply 6 is significantly increased.

With reference to FIG. 5, the manufacturing process for producing an extrusion profile 1 according to an exemplary embodiment of the disclosure and, in particular, for laminating fiber layers 6 is shown schematically and is explained in more detail below: FIG. 6 shows a section of a production line 40 for producing an extrusion profile 1 according to the disclosure, into which an extrusion semi-finished product produced by an extrusion die (not shown) is conveyed (from the right in the figure). Basically, the laminating line 40 is divided into the following stations: infeed area 43, primer area 45, transfer area 47 and outfeed area 49. Basically, the extrusion semi-finished product 41 and the later finished extrusion profile 1 are conveyed through the laminating line 40 by means of a plurality of conveying rollers 51 in the longitudinal direction of the extrusion profile according to a conveying direction F. In the inlet area 43, the extrusion semi-finished product 3 is substantially delivered with a profile temperature in the range of 18° C. to 25° C. In the primer area 45, there is a primer station 53 for applying the primer evenly and over the entire surface of the extrusion profile side to be laminated with the fiber layer 6, which can be, for example, an inner or an outer side 22, 23 of the finished window or door. An application and drying section 54 for the primer is provided between the primer area 45 and the transfer area 47.

In the transfer area 47, the layer to be laminated, in particular fiber layer 6 made of textile, wood veneer or leather fiber material, for example, is supported on a roller 56. A strand 57 of the fiber layer 6 to be laminated is then continuously unwound from the roller 46 essentially synchronously and/or coordinated with the conveying F of the semi-finished extrusion product 41 and coated on one side on a laminating surface with adhesive, which is applied by means of a nozzle 59 upstream of a laminating roller 61, which presses the fiber layer 6 onto the plastic extrusion profile 3.

In contrast to prior art PVC film lamination onto plastic extrusion profiles, it has been found that the quantity of adhesive must be significantly increased to improve the adhesive effect with fiber layers, and in particular adhesive quantities in the range of 80 g/m² are necessary. Furthermore, preheating of the fiber ply 6 is carried out immediately prior to adhesive application, and it has been found that significantly higher temperatures are necessary, for example in the range of 70° C. to 120° C. For good adhesion, it has been identified that a temperature of at least 55° C. must be maintained in the area of the laminating roller 61. Optionally, a hot air blower or other heat air generator 63 can be connected to the laminating roller 61.

Trimming can be carried out by means of a separation device 65. Subsequently, in particular in the area of the profile outlet 49, a further application of protective films can take place, which are provided by respective rollers 67, 69 and are applied to the upper and lower sides 22, 23 of the extrusion profile 1 according to the disclosure. This can be done by an adhesive applied to the protective films.

The features disclosed in the foregoing description, figures, and claims may be significant, both individually and in any combination, for the realization of the disclosure in the various embodiments.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### REFERENCE LIST

1 profile
3 profile semi-finished product
6 fiber layer
7 glazing
9 receptacle
11, 13 glazing seal
15 profile base
17 screen profile
19 sealing surface
21 profile outer side
23 profile outer web
25 sealing bar
27 sealing gap
29, 31 end
31 primer
33 adhesive
35 connection surface
37 bonding agent
39 varnish
41 semi-finished extrusion product
43 inlet area
45 primer area
47 transfer area
49 outlet area
51 conveyor roller
53 primer station
54 impact and dry section
56 roller
57 strand
59 nozzle
61 laminating roller
63 heat air generator
65 separation device
67,69 roller
100 plastic extrusion profile
103 extrusion semi-finished product
105 aluminum screen
107 glazing
109 receptacle
111, 113 sealing element
115 profile base
117 screen profile
119 sealing surface
121 extrusion profile exterior
123 profile outer web
125 sealing web
127 sealing gap
129, 131 end

1. An extrusion profile for a door and/or window part, comprising:
an outer side of the profile; and
a fiber layer laminated at least partially onto the outer side of the profile by an adhesive.

2. The extrusion profile according to claim 1, wherein the fiber layer comprises at least 50% natural fibers or is produced to include at least 50% renewable raw materials.

3. The extrusion profile according to claim 1, wherein the fiber layer is selected from the group consisting of: textile fibers, wood fibers, leather fibers and leather fiber materials.

4. The extrusion profile according to claim 3, wherein the textile fibers have a fluid-repellent property and/or a particle-repellent property.

5. The extrusion profile according to claim 4, wherein the textile fibers are subjected to a treatment modifying the fluid-repellent and/or particle-repellent property of textile.

6. The extrusion profile according to claim 4, wherein the fluid-repellent property and/or particle-repellent property is applied by spraying or coating with a silane-based solution.

7. The extrusion profile according to claim 4, wherein the fluid-repellent property and/or particle-repellent property is applied by printing the textile fiber layer with a silane-based solution.

8. The extrusion profile according to claim 1, wherein the fiber ply is a leather fiber material having a leather content in the range from 50 wt. % to 85 wt. % and a binder content in the range from 7 wt. % to 40 wt. % based on a total dry mass of the fiber ply.

9. The extrusion profile according to claim 8, wherein the fiber ply further comprises at least one additive of at most 10 wt. %, based on the total dry mass of the fiber ply.

10. The extrusion profile according to claim 9, wherein the at least one additive is a pigment.

11. The extrusion profile according to claim 8, wherein the leather fiber fabric is provided with at least one pigmentation comprising at least one lightfast pigment.

12. The extrusion profile according to claim 1, wherein the fiber layer has a thickness from 0.05 mm to 0.5 mm.

13. The extrusion profile according to claim 1, wherein a connecting surface of the fiber layer connectable to the profile is at least partially coated with a varnish.

14. The extrusion profile according to claim 13, wherein the varnish comprises polyester varnish, epoxy resin varnish, alkyd resin varnish, acrylic varnish, Polyurethane (PU) varnish and/or a Polyvinylidene Fluoride (PVDF) coating.

15. The extrusion profile according to claim 1, wherein the adhesive is a hotmelt adhesive and/or has a layer thickness from 80 g/m² to 100 g/m².

16. The extrusion profile according to claim 15, wherein the hotmelt adhesive is a single-component hotmelt adhesive based on Polyurethane (PU).

17. A method for producing an extrusion semi-finished product, comprising:
extruding an extrustion profile to produce the extrustion semi-finished product; and
laminating a fiber layer at least partially onto an outer side of the extrusion semi-finished product using an adhesive.

18. A door and/or window part comprising the profile according to claim 1.

19. The door and/or window part according to claim 18, wherein the door and/or window part is a door and/or window frame part or a door and/or window leaf part.
